(19) United States
(12) Patent Application Publication
(10) Pub. No.: US 2006/0083132 A1
(43) Pub. Date: Apr. 20, 2006

(54) Method and apparatus for improving recording optical disk writing quality of optical disk writer

(75) Inventor: Te-Yi Chang, Taipei (TW)

Correspondence Address: G. LINK Co., LTD., PMB 174, 931 West 75th Street, Suite 137, Naperville, IL, 60565, US

(73) Assignee: BEHAVIOR COMPUTER TECH CORP.

(21) Appl. No.: 10/966,514

(22) Filed: Oct. 18, 2004

(51) Int. Cl. G11B 5/09

(52) U.S. Cl. 369/47.5; 369/47.53; 369/53.1

(57) ABSTRACT

This invention relates to a method of improving the writing quality of an optical disk writer, and the writing method comprises the steps of: writing data into a plurality of blocks divided from the inner loop to the outer loop of the recording optical disk and each block corresponding to a weighted power; adding a constant writing power used at the current writing position of the optical disk writer to a weighted power corresponding to the block of the current writing position to obtain an actual writing power for writing data into the current writing position of the writer.

### FIELD OF THE INVENTION

The present invention relates to a method of controlling the writing power of an optical disk writer, more particularly to an apparatus, which adds a weighted power to the original writing power and then uses the sum for writing data on a recording optical disk according to the current writing location of the recording optical disk.

### BACKGROUND OF THE INVENTION

Since the speed of optical disk writers is increased day after day and various recording optical disks are sold in the market, it is necessary to adjust the optical disk writer automatically according to the brand and quality of each recording optical disk. The prior art optimum power calibration (OPC) uses some blocks of the recording optical disk to calibrate the power, and then writes the data of the whole block of the optical disk. However, the power is calibrated for some blocks of the whole optical disk only, and the calibrated power is a fixed writing power, which is not sufficient for the application of writing the whole optical disk. In fact, all blocks of the recording DVD disk adopting this writing method cannot obtain consistent writing quality.

Although another prior art related to a running optimum power calibration (Running OPC) can overcome the foregoing shortcoming of power calibration, the bandwidth issue caused by the OPC is difficult to overcome when such prior art is applied to the optical disk writer. It also causes high manufacturing cost to the optical disk writer, which is one of the major shortcomings of such writer.

In view of the shortcomings of the prior art as described above, the inventor of the present invention based on years of experience in the related block to perform extensive research and development and finally invented a method of writing all blocks of a whole optical disk with a consistent writing quality.

### SUMMARY OF THE INVENTION

The primary objective of the present invention is to provide a method and an apparatus for improving the writing quality of an optical disk writer.

To achieve the foregoing objective, the method for improving the writing quality of an optical disk writer comprises the steps of: dividing a plurality of blocks from the inner loop to the outer loop of a recording optical disk; defining a weighted power corresponding to each block; adding a constant writing power of the current writing position of the writer to a weighted power corresponding to the block of the currently writing position to obtain an actual writing power; and writing data into the current writing position of the writer by the actual writing power.

Further, to achieve the foregoing objective of the present invention, the optical disk writer for improving the writing quality comprises: an optical pickup head; a controller for adding a constant writing power used in the current writing position of the optical disk writer to a weighted power corresponding to the block of the currently writing position to obtain an actual writing power; and writing data into the current writing position of the writer by the actual writing power and using the optical pickup head with the actual writing power to write data into the current writing position of the optical disk writer; wherein the block for writing data into a recording optical disk one of the plurality of blocks divided from the inner loop to the outer loop of the recording optical disk with each block corresponding to a weighted power.

### BRIEF DESCRIPTION OF THE DRAWINGS

The present invention can be more fully understood by reference to the following description and accompanying drawings, in which:

FIG. 1 is a view of the structure of the optical disk writer according to the present invention;

FIG. 2 is a flow chart of the method for improving the writing quality of an optical disk writer according to the present invention;

FIG. 3 is a view of the states of the plurality of blocks logically divided from the inner loop to the outer loop of the recording optical disk for writing in data according to the present invention;

FIG. 4 is a view of the waveform for examining the writing quality after the optical disk writer writes data into the recording optical disk according to the method of the present invention;

FIG. 5 is a view of the waveform for examining the writing quality after the optical disk writer writes data into the recording optical disk with the constant writing power originally used in the current writing position according to the method of the present invention;

FIG. 6 is a view of the waveform of the PI error percentage obtained from reading data after the optical disk writer writes data into the recording optical disk according to the method of the present invention; and

FIG. 7 is a view of the waveform of the PI error percentage obtained from reading data after the optical disk writer writes data into the recording optical disk with the constant writing power originally used at the current writing position without adopting the method of the present invention.

### DETAILED DESCRIPTION OF THE INVENTION

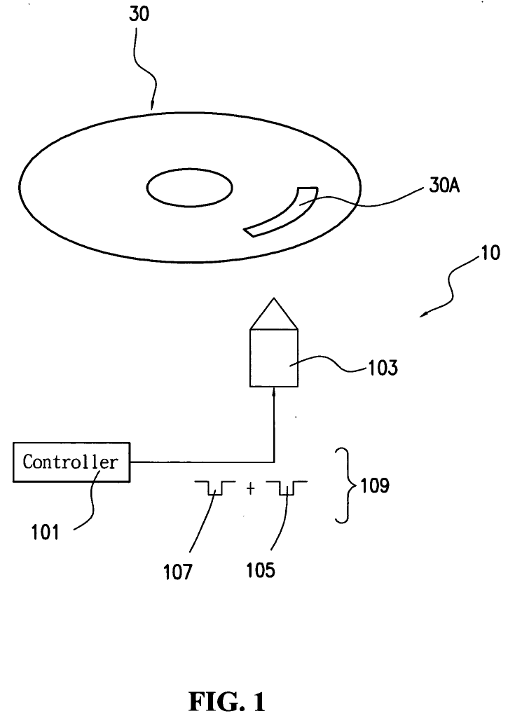

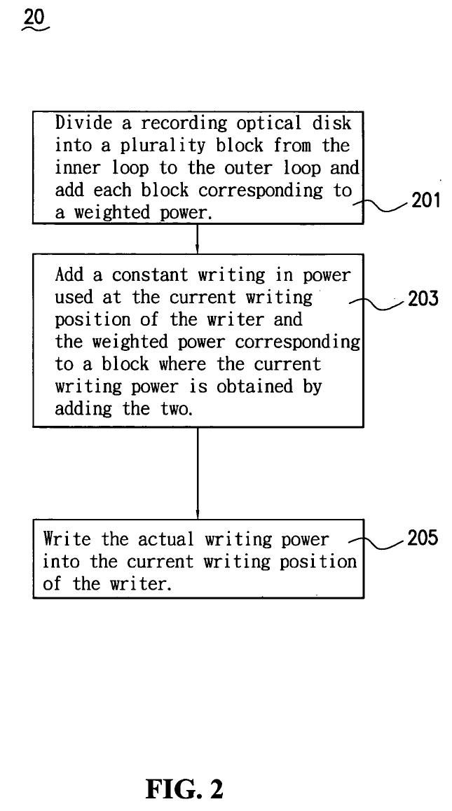

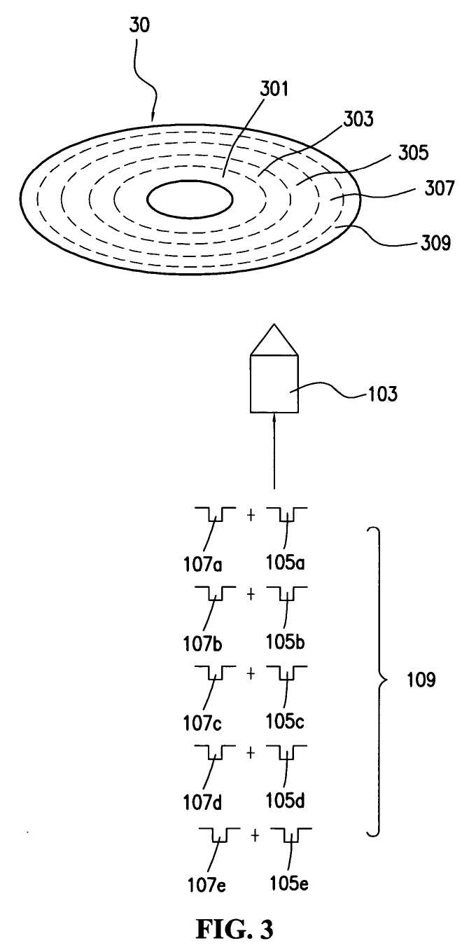

Please refer to FIG. 1 for the structure of the optical disk writer according to the present invention and FIG. 2 for the flow chart of the writing method for improving the writing quality according to the present invention. The writing method 20 for improving the writing quality of the optical disk writer comprises the following steps. In Step (201), a recording optical disk 30 is divided into a plurality of blocks from an inner loop to an outer loop of the recording optical disk 30, and each block corresponds to a weighted power. Please refer to FIG. 3 for the states of the plurality of blocks logically divided from the inner loop to the outer loop of the recording optical disk. In FIG. 3, the recording optical disk 30 is divided into 5 blocks 301, 303, 305, 307, 309. Each block 301˜309 corresponds to a weighted power 105a, 105b, 105c, 105d, 105e respectively. In practical applications, the recording DVD disk is divided into 36 blocks from the inner loop to the outer loop for every 10000 hex (hexadecimal) logical blocks as a unit from LBA (Logical Block Address) 000000 hex (hexadecimal) according to the LBA 240000 hex (hexadecimal) method as shown in Step (201). Of course, each of these 36 blocks corresponds to a weighted power.

In Step (203), the constant writing power 107a˜107e used in the current writing position 30A of the optical writer 10 is added to a weighted power 105a˜105e corresponding to the blocks 301˜309 at the current writing position 30A to obtain an actual writing power 109. FIG. 1 is used as an example for describing Step 203. In FIG. 1, an optical disk writer 10 writes data into the current writing position 30A of the recording optical disk 30, and the current writing position 30A falls in the range of the block 303, and the block 303 corresponds to the weighted power 105b. Therefore, the actual writing power 109 at the current writing position 30A is equal to the sum of the weighted power 105b and the constant writing power 107b used at the current writing position 30A.

In Step (205), data is written into the current writing position 30A of the optical disk writer 10 by the actual writing power 109. Step 205 is implemented by using a controller 101 of the optical disk writer 10 to set the writing power of the optical pickup head 103 as the actual writing power 109 and writes data into the current writing position 30A of the recording optical disk 30.

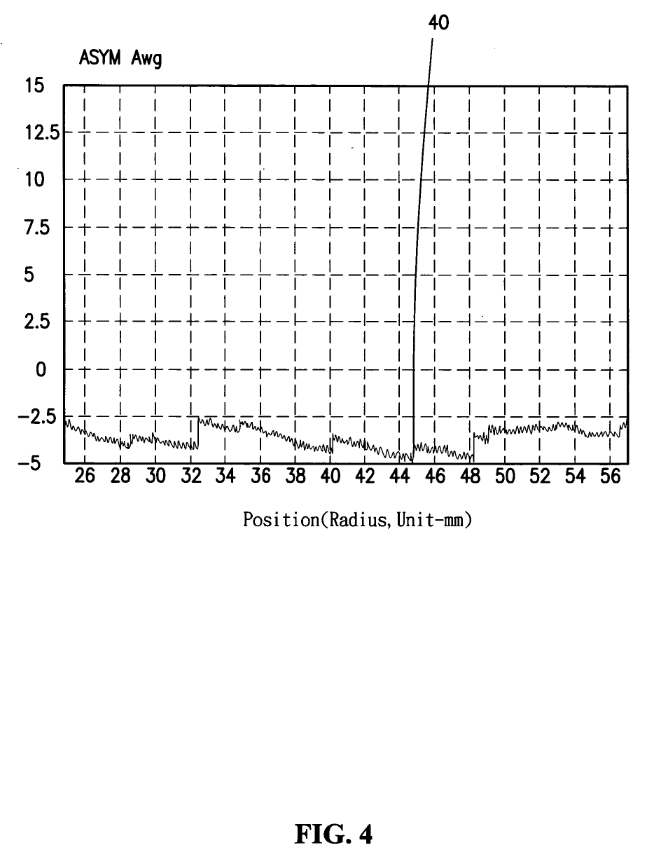

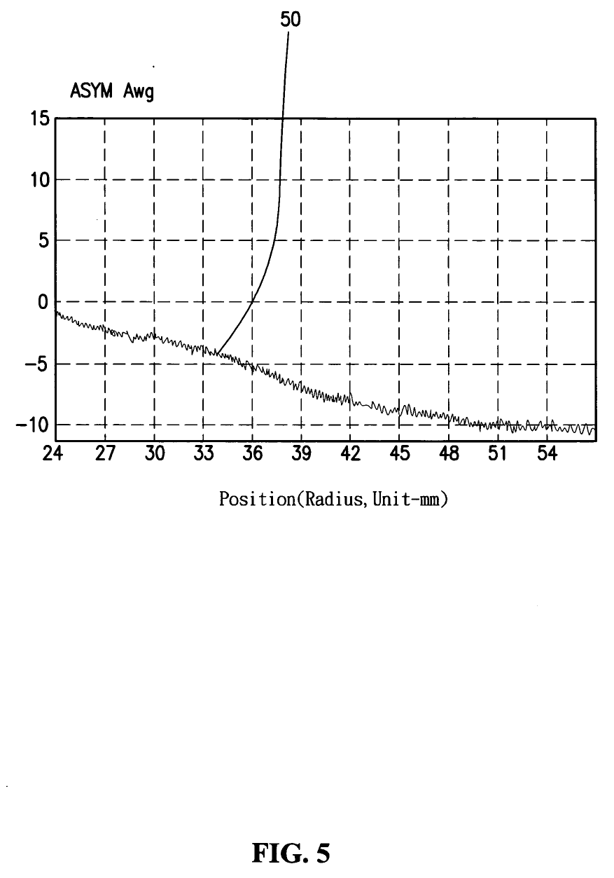

Please refer to FIG. 4 for the waveform for examining the writing quality after the optical disk writer writes data into the recording optical disk according to the method of the present invention and FIG. 5 for the waveform for examining the writing quality after data is written into the recording optical disk by using the constant writing power originally used for the current writing position without using the method of the present invention. The waveform 40 shown in FIG. 4 and the waveform 50 shown in FIG. 5 indicates that when data is read from the recording optical disk 30, each position on the recording optical disk 30 shows an asymmetry. It is obvious that the waveform 40 performs better than the waveform 50. Overall, a symmetric data reading waveform can be obtained when the recording optical disk 30 uses the method 20 according to the present invention to read data from the recording optical disk 30.

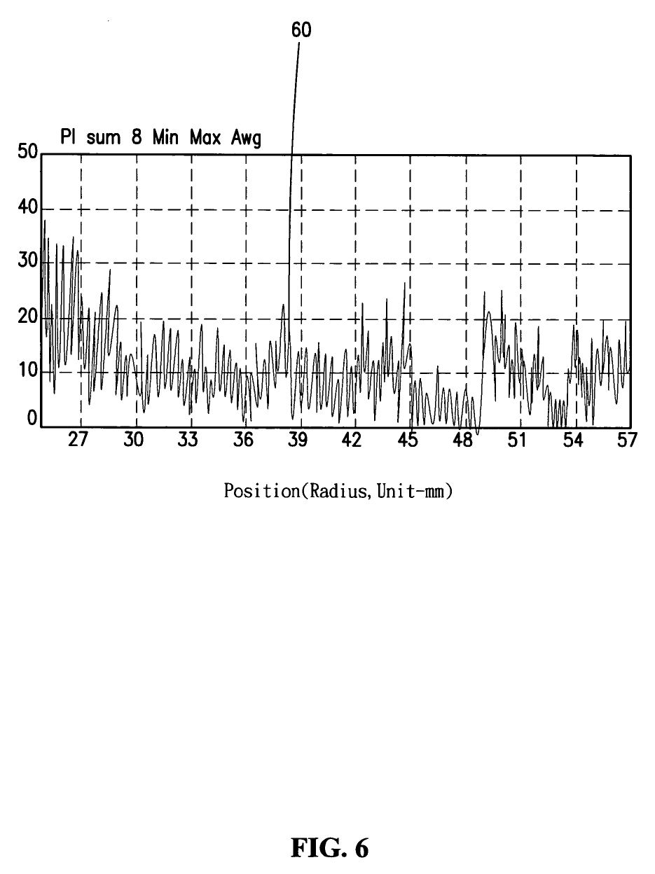

Please refer to FIG. 6 for the waveform of the PI error percentage obtained from reading data after the optical disk writer writes data into the recording optical disk according to the method of the present invention and

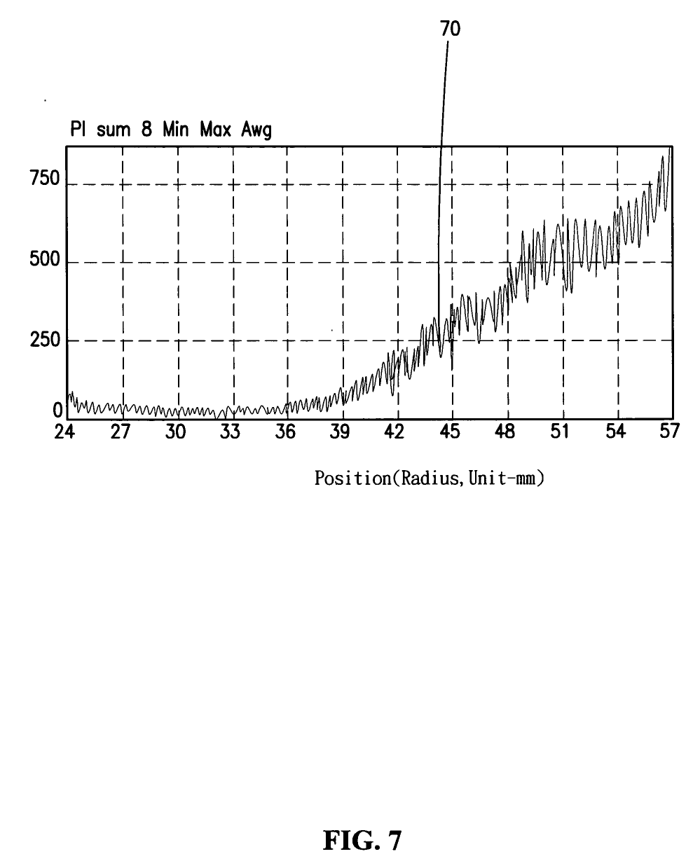

FIG. 7 for the waveform of the PI error percentage obtained from reading data after the optical disk writer writes data into the recording optical disk with the constant writing power originally used at the current writing position without adopting the method of the present invention. The waveform 60 shown in FIG. 6 and the waveform 70 shown in FIG. 7 indicate the error percentage PI of the error occurred at each position when reading data from the recording optical disk. Similarly, it is obvious that the waveform 60 performs better than the waveform 70. Therefore, the present invention can greatly reduce the PI error for reading data if such data is written into a recording optical disk 30 according to the method 20 of the present invention.

The optical disk writer 10 according to the method 20 of the present invention comprises: an optical pickup head 103 and a controller 101; wherein the controller 101 is used for adding a constant writing power 107a˜107e used at the current writing position 30A of the optical disk writer 10 and a weighted power 105a˜105e corresponding to the blocks 301˜309 at the current writing position 30A to obtain an actual writing power 109 and setting the writing power of the optical pickup head 103 as the actual writing power 109 to write data into the current writing position 30A of the recording optical disk 30.

The value of the foregoing weighted power 105 depends on the type of various recording optical disks 30 for its setting. It is preferably to test the writing method 20 of the present invention with various recording optical disks 30 first before determining the value of the weighted power 105 for different recording disks 30 according to the test results on the writing quality of different recording optical disks 30.

The value of the foregoing weighted power 105 of the present invention is set according to each block 301˜309 of the recording optical disk 30. It is preferably to test the writing method 20 of the present invention with a specific recording optical disk 30 first before determining the value of the weighted power 105 corresponding to each block 301˜309 according to the test results on the writing quality of different blocks 301˜309 in the recording optical disk 30.

The present invention does not regard the value of the constant writing power 107. The same value of the constant writing power is used to write data into different blocks of the recording optical disk 30 or use different values of the constant writing power for different blocks.

The recording optical disk 30 according to the present invention could be a DVD+R disk, a DVD+RW disk, a DVD-R disk, and a DVD-RW disk. The optical disk writer 10 of the present invention could be a DVD writer.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for improving recording optical disk writing quality for optical disk writer, comprising the steps of:
dividing a recording optical disk into a plurality of blocks from an inner loop to an outer loop with each block corresponding to a weighted power;
adding a constant writing power used at a current writing position of said optical disk writer to said corresponding weighted power to obtain an actual writing power; and
writing data into said current writing position of said optical disk writer with said actual writing power.

2. The method for improving recording optical disk writing quality for optical disk writer of claim 1, wherein said recording optical disk is selected from the collection of a DVD+R disk, a DVD+RW disk, a DVD-R disk, and a DVD-RW disk.

3. The method for improving recording optical disk writing quality for optical disk writer of claim 1, wherein said optical disk writer is a DVD writer.

4. The method for improving recording optical disk writing quality for optical disk writer of claim 1, wherein said recording optical disk comprising at least one of the said blocks.

5. The method for improving recording optical disk writing quality for optical disk writer of claim 1, wherein said weighted power has a value set according to the type of various recording optical disks.

6. The method for improving recording optical disk writing quality for optical disk writer of claim 1, wherein said weighted power has a value set according to said each block of said recording optical disk.

7. The method for improving recording optical disk writing quality for optical disk writer of claim 1, wherein said constant writing power is a writing power originally used for a current writing position of said writer.

8. An optical disk writer for improving writing quality, comprises:
an optical pickup head;
a controller, for adding a constant writing power used at said current writing position of said optical disk writer to a weighted power corresponding to a block of said current writing position to obtain an actual writing power, and using said optical pickup head to write data into the block of said current writing position of said writer; wherein said block is divided into a plurality of blocks an inner loop to an outer loop of said recording optical disk and said each block corresponds to a weighted power.

9. The optical disk writer for improving writing quality of claim 8, wherein said recording optical disk is selected from the collection of a DVD+R disk, a DVD+RW disk, a DVD-R disk, and a DVD-RW disk.

10. The optical disk writer for improving writing quality of claim 8, wherein said optical disk writer is a DVD writer.

11. The optical disk writer for improving writing quality of claim 8, wherein said recording optical disk comprising at least one of the said blocks.

12. The optical disk writer for improving writing quality of claim 8, wherein said weighted power has a value set according to the type of various recording optical disks.

13. The optical disk writer for improving writing quality of claim 8, wherein said weighted power has a value set according to said each block of said recording optical disk.

14. The optical disk writer for improving writing quality of claim 8, wherein said constant writing power is a writing power originally used for a current writing position of said writer.
